(19) United States
(12) Patent Application Publication
(10) Pub. No.: US 2013/0073271 A1
(43) Pub. Date: Mar. 21, 2013

(54) STATIC FAULT TREE ANALYSIS SYSTEM AND METHOD FROM SYSTEM MODELS

(71) Applicant: Jianwen Xiang, Tokyo (JP)

(72) Inventor: Jianwen Xiang, Tokyo (JP)

(73) Assignee: NEC CORPORATION, Tokyo (JP)

(21) Appl. No.: 13/699,359

(22) PCT Filed: May 23, 2011
(86) PCT No.: PCT/JP2011/061738

§ 371 Date: Nov. 21, 2012

(30) Foreign Application Priority Data
May 24, 2010 (JP) 2010-117945

(51) Int. Cl. G06G 7/48

(52) U.S. Cl. 703/6

(57) ABSTRACT

The present invention is a system for static fault tree analysis from system models comprising: system configuration input unit that inputs system configurations and top events of the systems to be analyzed; system model library that stores a set of system architecture models and component error models; and fault tree analyzer that analyzes fault trees of the system from the top events in terms of decomposition rules defined in the component error models. The system configurations and top events are instances of the system architecture models and the fault events of the component error models stored in the system model library, respectively. The system architecture models delimit classification of and definitions of physical and semantic relations between different components. The component error models define different fault events of components and their Boolean logic relationships called decomposition rules which cover both functional and sequential dependencies for fault tree analysis.

### TECHNICAL FIELD

The present invention is concerned with methods and systems for automatic system reliability analysis from system configurations, especially with the methods and systems for qualitative reliability analysis of computer systems with static fault tree analysis (FTA) and system models.

### BACKGROUND ART

An example of the related fault tree analysis (FTA) is presented in non-patent literature 1. Such a traditional FTA typically uses dynamic logic gates, such as FDEP (Functional Dependency) and PAND (Priority AND), to model functional and sequential dependencies between different events.

However, such dynamic fault trees typically require extra cost for system administration and maintenance, since sequential rather than combinational information (i.e., history rather than combinations of occurrences of events) are needed to analyze the fault tree states at runtime, which could be a key problem in analysis of large and complex systems. In addition, the dynamic fault trees are typically drawn by hand, and thus, no systematic and automatic method or model has been proposed to help engineers develop fault trees in an efficient and correct way.

Some other examples of semi-automatic system fault tree analysis with FTA in regard to specific domains and systems have been presented in patent literatures 1, 2, and 3. For instance, as shown in FIGS. 14 and 15, such a previous system presented in the patent literature 3 uses the layout (three dimension CAD data) of the nuclear power plant as the input, and uses a FT figure DB means to save registered fault trees of some specific devices. Given a particular top event of device, if its fault tree already exists in the aforementioned FT figure DB means, then a fault tree could be generated for the top event; otherwise manual revision is needed. A common problem of these previous systems and methods (e.g., the patent literatures 1, 2, and 3) is that, there is no formal parameterized system architecture and component error (fault) models for the fully automatic development of fault trees, and thus they are typically limited to specific domains and systems.

In addition, these inventions, in which sequential dependency between different events are generally omitted, only focus on traditional simple static logic relations such as AND and OR.

### CITATION LIST

### Patent Literature

PTL 1: JAPANESE Patent No. 2853215

PTL 2: JP-P1995-200534A

PTL 3: JP-P2003-149377A

### Non-Patent Literature

NON-PTL 1: J. B. Dugan, S. J. Bavuso, and M. A. Boyd, Dynamic Fault-Tree Models for Fault Tolerant Computer Systems, IEEE Trans. on Reliability, Vol. 41, No. 3, 1992, pp. 363-377.

### SUMMARY OF INVENTION

### Technical Problem

The first problem is that in the above-described technologies, manual development of fault trees is difficult and error-prone, especially in the case of large and complex system analysis.

The reason is that most of FTA tools that are currently used do not consider how to develop some formal system architecture and component error models for the automatic development of fault trees, especially in the case of fault tolerant computer systems. Rather, they mainly focus on how to calculate the minimal cut sets (MCS: smallest combinations of basic events which will result in the top events) and failures rates of given fault trees which are assumed to be developed by the engineers by hand in the first place.

The second problem is that functional and sequential dependencies between events of components are usually modeled with some dynamic gates, which may introduce potential semantic troubles and require extra cost for the system administration and maintenance at runtime.

The reason is that the formal semantics of some dynamic gates have not been well defined, and the analysis of dynamic fault tree states requires history (sequential) information, which may cause trouble and increase cost in the analysis of large scale systems.

Thereupon, the present invention has been accomplished in consideration of the above-mentioned problems, and an objective of the present invention is to provide a system and a method for automatically developing and analyzing fault trees from system models.

Another objective of the present invention is to present a model to define functional and sequential dependencies between events with standard static logic gates.

### Means for Solving Problem

The present invention for solving the above-mentioned problems is a system for static fault tree analysis from system models which includes a system configuration input means that inputs system configurations and top events of the system to be analyzed, a system model library means that stores a set of system architecture models and component error models, and a fault tree analysis means that analyzes fault trees of the system from the aforementioned top event in terms of decomposition rules defined in the aforementioned component error models, wherein the aforementioned system configurations and the aforementioned top events are instances of the system architecture models and the fault events of the component error models stored in the aforementioned system model library means, respectively, the aforementioned system architecture models delimit classification of and definitions of physical and semantic relations between different components, and the aforementioned component error models define different fault events of components and their Boolean logic relationships called decomposition rules which cover both functional and sequential dependencies for fault tree analysis.

The present invention for solving the above-mentioned problems is a method for static fault tree analysis from system models which includes a step of storing, in a system to be analyzed, a set of system architecture models that delimit classification of and definitions of physical and semantic relations between different components, and component error models that define different fault events of components and their Boolean logic relationships called decomposition rules which cover both functional and sequential dependencies for fault tree analysis, a step of selecting top events of the system to be analyzed, and a step of analyzing fault trees from the aforementioned top events in terms of decomposition rules defined in the aforementioned component error models.

The present invention for solving the above-mentioned problems is a program for causing a computer to analyze static fault trees from system models, which causes the computer to execute a process of storing, in a system to be analyzed, a set of system architecture models that delimit classification of and definitions of physical and semantic relations between different components, and component error models that define different fault events of components and their Boolean logic relationships called decomposition rules which cover both functional and sequential dependencies for fault tree analysis, and a process of analyzing fault trees from the selected top events in terms of decomposition rules defined in the aforementioned component error models.

### Advantageous Effect of Invention

The present invention makes it possible to automatically develop the fault trees of the system from the instances of the system architecture models and the top events with regard to the component error models.

### BRIEF DESCRIPTION OF DRAWINGS

FIG. 1 is a block diagram illustrating a configuration of the first implementation mode of the present invention.

FIG. 2 is a flowchart illustrating an operation of the first implementation mode.

FIG. 3 is a block diagram illustrating configurations of the second implementation mode and the third implementation mode of the present invention.

FIG. 4 is a flowchart illustrating an operation of the second implementation mode.

FIG. 5 is a flowchart illustrating an operation of the third implementation mode.

FIG. 6 is a view illustrating a specific example of an operation of the first implementation mode.

FIG. 7 is a view illustrating an example of the system architecture model (UML view).

FIG. 8 is a view illustrating an example of a network server architecture model (Maude specification).

FIG. 9 is a view illustrating an example of the component error model (Maude specification).

FIG. 10 is a view illustrating an example of a MCS calculation rule (Maude specification).

FIG. 11 is a view illustrating an example of the system configuration input (Maude specification).

FIG. 12 is a view illustrating MCS outputs with regard to the input of FIG. 11.

FIG. 13 is a view illustrating an example of a conversion from a PAND gate to an AND gate.

FIG. 14 is an explanatory view of a processing procedure that is performed by a reliability analysis support device of the patent literature 3.

FIG. 15 is a detailed explanatory view of an FT view preparation step of the patent literature 3.

### DESCRIPTION OF EMBODIMENTS

An outline of the present invention will be explained.

The static fault tree analysis (FTA) system from the system models of the present invention includes a system configuration input means, a system model library means, and a fault tree analysis (FTA) means.

The system configuration input means is used to input the (physical and semantic) configuration of the system to be analyzed. The input configuration follows the definitions of system architecture models defined in the system model library means below.

The system model library means is used to save a set of system architecture models and component error models, and a set of minimal cut set calculation rules of the fault trees.

The system architecture models include classification of and relations between components, in which the relations include potential physical connections and compositions, and semantic requirements such as functional dependencies between the components.

The component error models include definitions of different fault and conditional events of components, in which both functional dependency between components and sequential dependency between fault events are covered. The axioms of the component error models play the role as decomposition rules for fault tree construction (analysis).

In addition, the minimal cut set (MCS) calculation rules are used to calculate the minimal cut sets of the analyzed fault trees.

The fault tree analysis (FTA) means is used to generate and analyze the fault trees of the inputted system configurations in terms of the aforementioned fault tree decomposition and MCS calculation rules defined in the system model library means.

Hereinafter, the implementation modes of the present invention will be further explained in details.

The first implementation mode of the present invention will be explained in details by referring to the accompanied drawings.

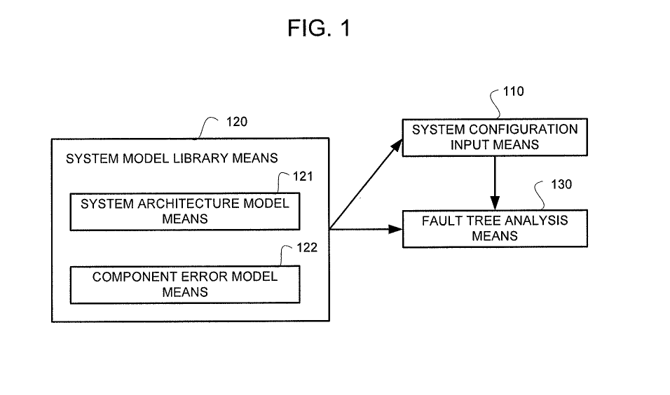

Referring to FIG. 1, the first implementation mode of the present invention includes a system configuration input means 110, a system model library means 120, and a fault tree analysis (FTA) means 130.

The system model library means 120 further includes a system architecture model means 121 and a component error model means 122.

Operations of these means are summarized as follows, respectively.

The system configuration input means 110 inputs the system configuration and the top event of the system to be analyzed. The system configuration must follow the definitions of the system architecture models defined in the system architecture model means 121 to be later described.

The system model library means 120 stores a set of system models for fault tree analysis (FTA). The system models can be further classified into two groups, namely system architecture models and component error models.

The system architecture model means 121 stores a set of system architecture models specifying the classification and properties of components. In this means, the properties are denoted by functions representing compositions of components, and potential physical connections and semantic (functional) relations between components.

The component error model means 122 stores a set of component error model specifying different component fault and conditional events and their logic relations. The axioms defined in the component error models play the role as fault tree decomposition rules.

The fault tree analysis (FTA) means 130 decomposes events from the aforementioned top events in terms of the aforementioned input system configurations and fault tree decomposition rules. That is, the fault tree analysis (FTA) means 130 analyzes the fault trees.

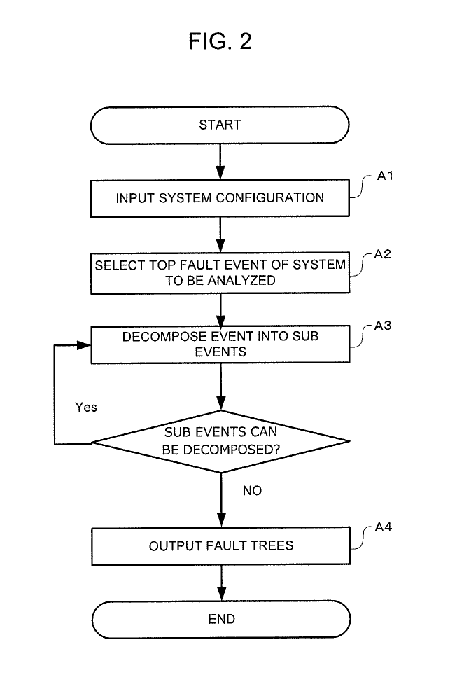

Next, an entire operation of this implementation mode will be explained in details by referring to flowcharts of FIG. 1 and FIG. 2.

Firstly, the system configuration is input by the aforementioned system configuration input means 110 (Step A1).

The user inputs (selects) a top fault event of the system to be analyzed (Step A2).

The top event is decomposed into some sub events by the fault tree analysis (FTA) means 130 in terms of some decomposition rule defined in the component error model means 122 (Step A3).

Redo the decomposition (Step A3) for the sub events until there is no decomposition rule available for the decomposed sub events, i.e., they become basic events which are not further decomposable.

Finally the generated fault tree (comprising the basic events) is output.

Next, an effect of this implementation mode will be explained.

This implementation mode includes repeated decomposition of events in terms of the decomposition rules defined in the component error model means 122, and thus the fault trees of the input top events can be automatically generated.

Next, the second implementation mode of the present invention will be explained in details by referring to the accompanied drawings.

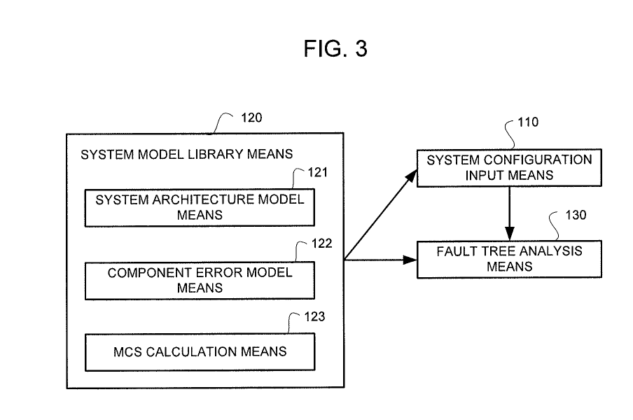

Referring to FIG. 3, the second implementation mode of the present invention is an extension of the first implementation mode, in which the aforementioned system model library means 120 further includes a MCS calculation means 123 that stores a set of calculation rules used for the calculation of MCS of the fault trees. Correspondingly, the fault tree analysis (FTA) means 130 of the second implementation mode is also used for the calculation of MCS in addition to the decomposition of events as mentioned in the first implementation mode.

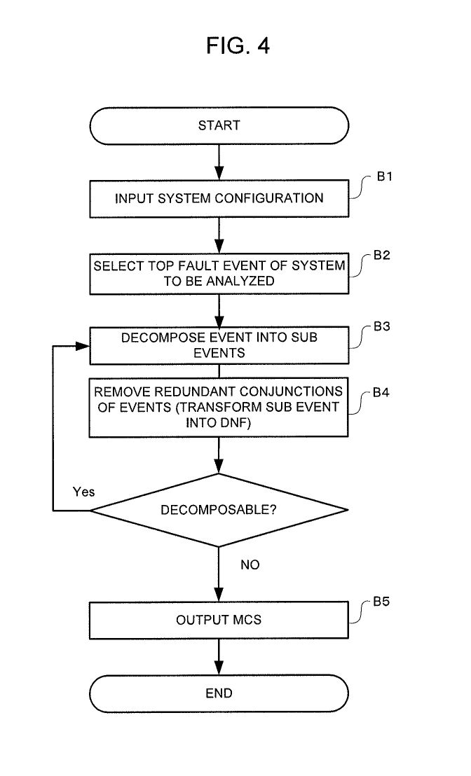

Next, an entire operation of this implementation mode will be explained in details by referring to flowcharts of FIG. 3 and FIG. 4.

The steps B1 to B3 are the same as the steps A1 to A3 of the first implementation mode, respectively. After decomposition of the top event, the sub events are then transformed into a Disjunctive Normal Form (DNF) in which the redundant conjunctions of events are also removed with the calculation rules defined in the MCS calculation means 123 (Step B4). For any event of the DNF, redo Step B3 and B4 until it becomes a basic event (i.e., indecomposable). Finally, when all the events become basic events, the final DNF is output as the MCS of the fault tree.

Next, an effect of the second implementation mode will be explained.

This implementation mode includes repeated decomposition of events and calculation of MCS, which can remove redundant nodes of the fault tree in a timely fashion, and thus the MCS of the fault tree could be calculated in an efficient way. However, since the calculation of MCS is carried out after each decomposition of event, the complete original fault tree without any calculation of MCS cannot be outputted in this implementation mode.

Next, the third implementation mode of the present invention will be explained in details by referring to the accompanied drawings.

Referring to FIG. 3, the third implementation mode of the present invention includes the means of the second implementation mode; however, the difference with the second implementation mode is that the third implementation mode consists of a different processing flow in terms of the event decomposition and MCS calculation steps mentioned below.

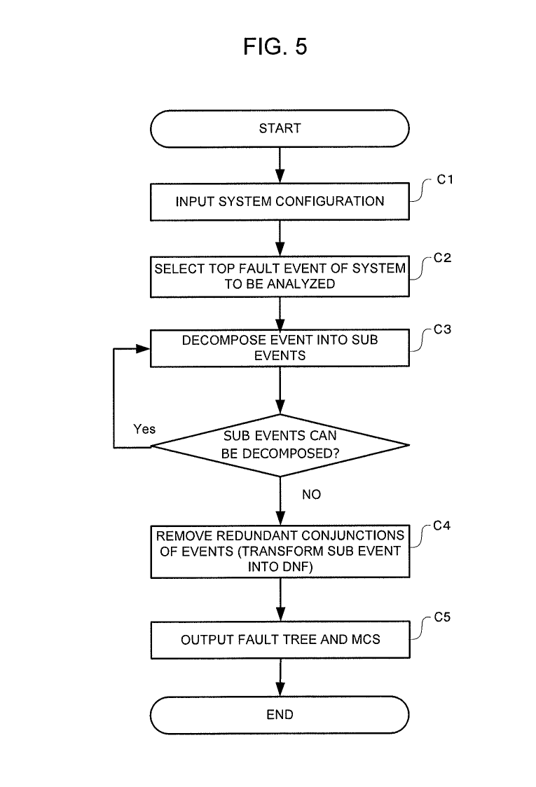

Next, an entire operation of this implementation mode will be explained in details by referring to flowcharts of FIG. 3 and FIG. 5.

This implementation mode also includes decomposition of events (Step C3) and calculation of MCS (Step C4), but the reduction is carried out only once after all the events become basic events (indecomposable) through repeated decomposition. Therefore, the complete original fault tree without any reduction and the minimal cut sets of the fault tree could both be output (Step C5).

Compared with the second implementation mode, the third implementation mode may spend more time for the calculation of MCS since no timely reduction has been carried out after each decomposition. However, the benefit of the third implementation mode is that the complete decomposition information is kept, and thus the original fault tree without any reduction can be output.

The implementation mode of the present invention described above has the following effect.

The first effect is that, given a configuration of a system, and a top undesired event of the system, the fault tree of the top event as well as the minimal cut sets of the fault tree can be automatically generated. The reason is that the input system configuration follows the definitions of system architecture models, and thus the fault tree and MCS can be developed and calculated in terms of the fault tree decomposition and MCS calculation rules defined in the system model library means, respectively.

The second effect is that the functional and sequential dependencies between components can be modeled with standard static logic gates rather than traditional dynamic gates. The reason is that by classifying internal and external fault events of a component, the functional dependency between different components can be represented with standard OR-gate; and by introducing extra dependent conditional event, the sequential dependency between component fault events can be handled with standard AND-gate.

### EXAMPLE 1

Next, an operation of the present invention will be explained by using specific examples.

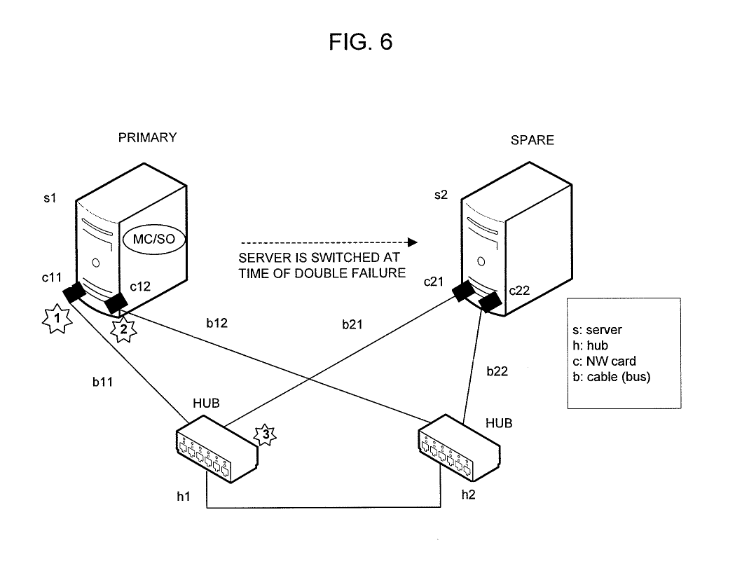

One high dependable network configuration is shown in FIG. 6. Hereinafter, a configuration of the system will be explained.

The system consists of two servers, s1 and s2, and s1 is the primary (active) one, while s2 is a spare to be activated when s1 fails.

Each server has two network cards, and respective network cards are cards of c11 (primary) and c12 (spare) of the primary s1, and cards of c21 (primary) and c22 (spare) of the stand-by s2.

There are two hubs h1 and h2, and two hubs are connected with the network cards c11, c12, c21 and c22 with wired cables b11 (between c11 and h1), b12 (between c12 and h2), b21 (between c21 and h1), and b22 (between c22 and h2).

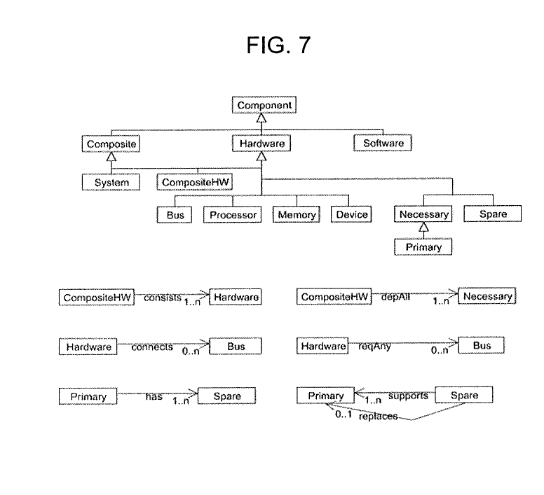

An example system architecture model denoted in a UML form is presented in FIG. 7.

This system architecture models are supposed to be saved in the system architecture model means 121, and they can be represented in different forms for one implementation mode. The UML graphical form of FIG. 7 is just one of the candidates for readability. Some annotations of FIG. 7 are as follows.

A component could be a composite component, hardware, or software. A hardware component could be a bus, memory, processor, or device, and it could be served as a necessary or spare component. A primary component is a necessary component which has at least one spare component. A composite hardware (composite HW) is both a composite component and a hardware component.

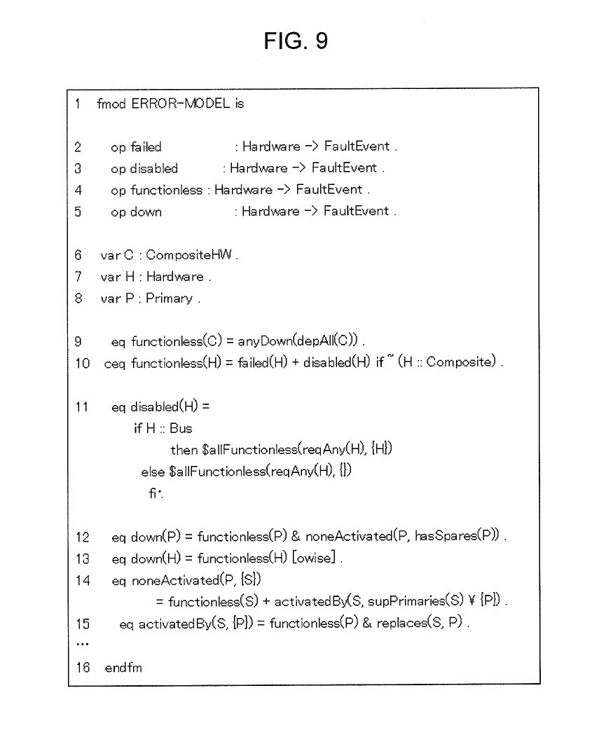

A composite hardware consists of one or several (sub) hardware components, and generally speaking, its functionality depends on that all of its necessary sub components work well, i.e., not down (the definition of the fault event down will be discussed later in FIG. 9). Therefore, as shown in FIG. 7, the relation “depAll” actually represents a kind of vertical functional dependency between composite and sub hardware components, and it is a sub relation of the physical composition relation “consists”.

A hardware component may connect to zero or several buses, and generally speaking, it requires any of the (connected) buses to be accessible, not disabled. Therefore, as shown in FIG. 7, the relation “reqAny” actually represents a kind of horizontal functional dependency between hardware and buses, and it is a sub relation of the physical connection relation “connects”.

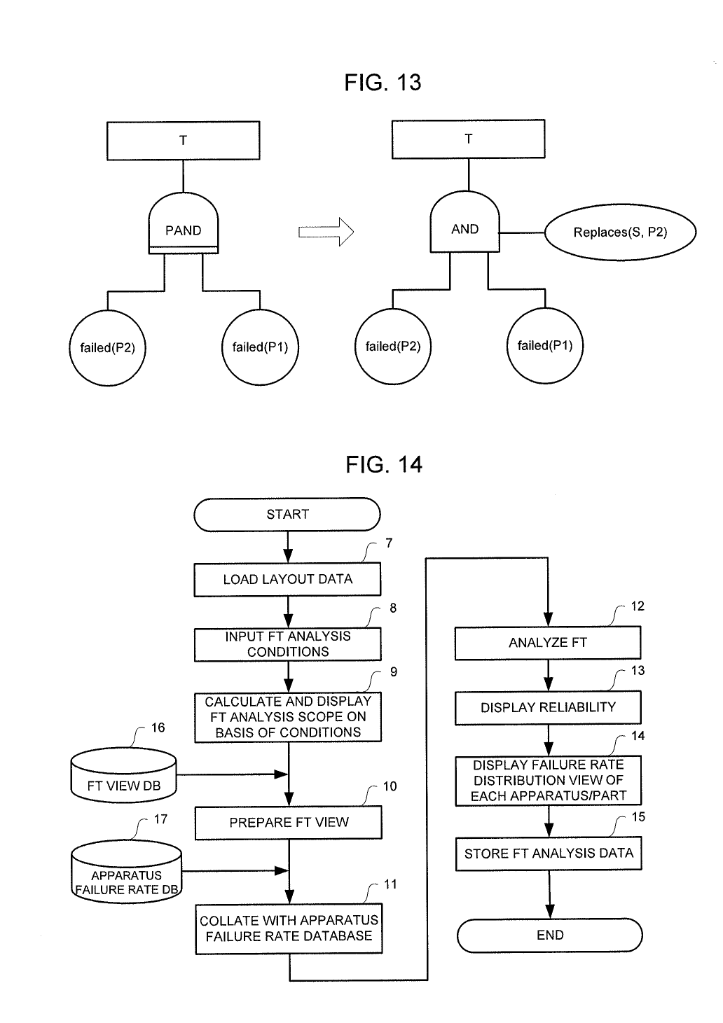

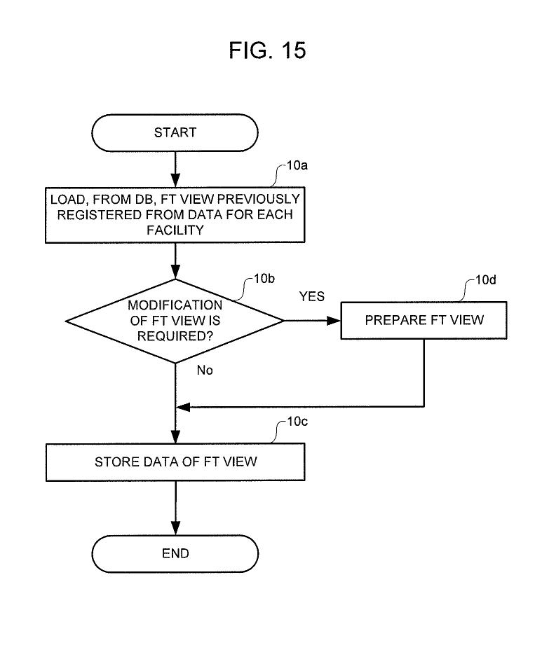

A primary (hardware) may have one or several spares, and a spare may support one or several primaries at the same time. Note that however, a spare can only replaces at most one primary (i.e., the first failed primary) at any time. The relation of replaces can be used to represent sequential fault events of two primaries which are supported by the same one spare. For instance, assume that there are two primary components, P1 and P2 which share the same one spare S, and a top event is defined as that P2 fails before the failure of P1 (which means that when P1 fails, the system consisting of P1 and S will fail since the spare S cannot be activated for P1). By introducing the conditional event replaces (S, P2), the above sequential dependency between the faults of P1 and P2 can be denoted by a standard static AND gate rather than a traditional PAND gate as shown in FIG. 13.

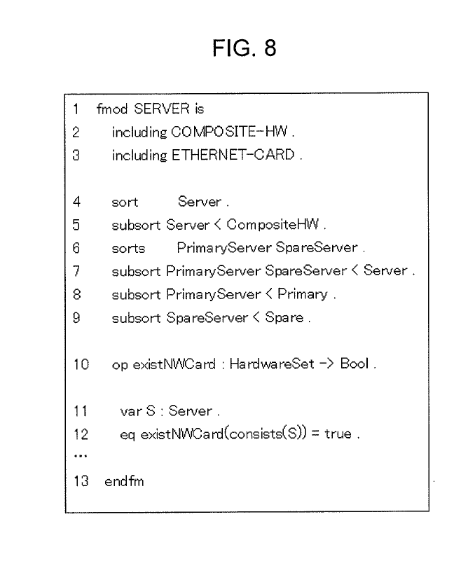

Moreover, FIG. 8 presents an example formal architecture model of network servers written with Maude, a formal specification and programming language. Some annotations of FIG. 8 are as follows (the line numbers are added for readability).

The matters described in lines 4 to 9 are data type (sort) and sub type definitions. For instance, a server is a composite hardware component. Additionally, the sub type relation is denoted by the symbol “<”.

The matter described in line 10 is the definition of a predicate, “existNWCard”, denoting that whether there exists a network card in a set of hardware components or not.

The matter described in line 11 is an equation (axiom) stating the property of that any network server must consist of some network cards. Note that “consists” is a function defined from a composite hardware component to a set of its sub hardware components as discussed in FIG. 7.

An example component error model written with Maude is presented in FIG. 9, which is supposed to be stored in the aforementioned component error model means 122. The equations defined in FIG. 9 play the role as decomposition rules for the fault tree development. Some annotations of FIG. 9 are as follows.

The matters described in lines 2 to 5 define four kinds of component fault events.

“failed” described in line 2 is the (primary) internal failure of a component, such as broken.

“disabled” described in line 3 is the (secondary) external fault of a component which is typically caused by the faults of other functional depended components, for instance, a memory may be disabled by a bus since the memory requires the bus for accessible.

“functionless” described in line 4 represents the union of the internal and external faults of a component.

“down” described in line 5 is typically used to denote that a primary component is functionless and none of its spares has been activated.

In lines 6 to 8, variable declarations for subsequent equations are described.

In lines 9 to 10, equations defining the semantics of functionless, i.e., equations defining that a composite component is functionless if and only if any of its depended sub necessary components is down (provided an assumption is made that any composite component must connect to other adjacent component through some of its subcomponents), and a non-composite component is functionless if and only if itself is failed or it is disabled are described. These two axioms represent the vertical and horizontal functional dependencies, respectively.

In line 11, an equation defining the semantics of disabled, i.e., an equation defining that a component is disabled if and only if all of its required buses become functionless is described. Additionally, since bus connections are transitive and could be iterative, the case splitting of bus and non-bus components as well as the second parameter of auxiliary function “$allFunctionless” are used to remove cyclic dependencies.

In lines 12 to 15, equations defining the semantics of down are described, that is, it is described to define that a primary component is down if and only if itself is functionless and none of its spares has been activated, and the down of a non-primary component is defined as equal to its functionless for convenience. The reason for a spare not activated for a primary component could be that the spare is functionless or it is activated by some other supported primary component before. Finally, the activation of spare for a primary component equals to that the primary is functionless and the spare replaces the primary (a conditional event).

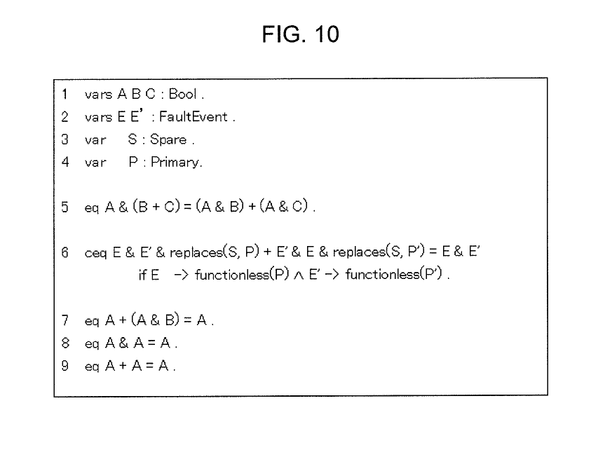

As for the MCS calculation means 123, some example rules are presented in FIG. 10. Some annotations are as follows.

In lines 1 to 4, variable declarations for subsequent equations are described. Note that the sort FaultEvent is a subsort of Bool.

In line 5, an equation for transforming a Boolean formula into a DNF is described.

In line 6, an equation for removing unnecessary conditional event replaces in the final MCS is described. The meaning of this equation is that suppose there are two primary components share the same one spare, and if there are two conjunctions stating that both of the two primary component are functionless, and the spare replaces the first and second primary component in the two conjunctions, respectively, then these two conjunctions could be combined into one conjunction consisting of only the two primary components.

In lines 7 to 9, equations for removing redundant cut sets (conjunctions) to get the minimal cut sets of the fault tree are described.

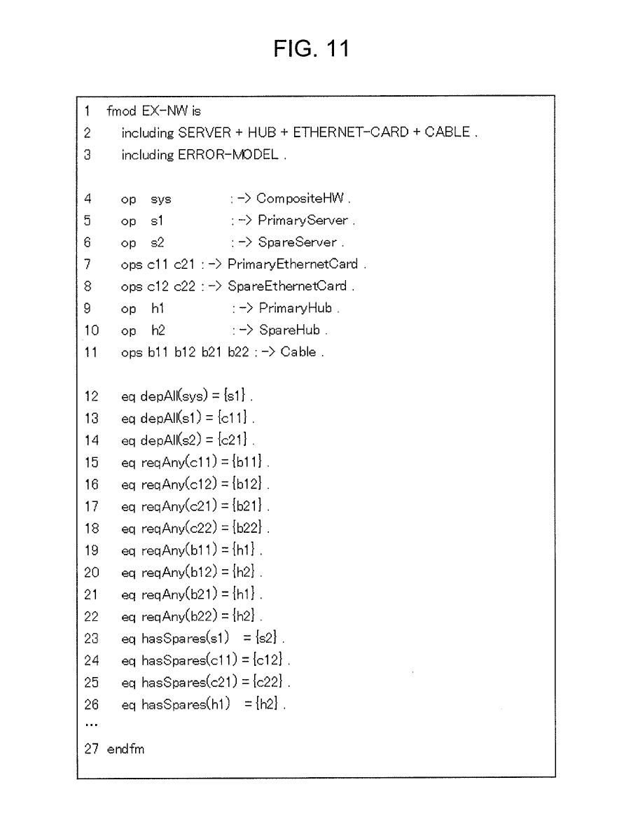

Based on the graphical representation of the example network configuration as shown in FIG. 6 and the example system architecture models as shown in FIGS. 7 and 8, we assume that an input of the logic representation of the example network configuration is denoted in a form such as shown in FIG. 11 (corresponding to Step A1 of FIG. 2). Some annotations are as follows.

For clarity, we omitted the formal specification for the physical connections between components, and only functional relations between components are presented. The functional relations could be derived from the physical connections for simplification, provided that certain rules have been added into the aforementioned system architecture model means 121. For instance, if an assumption is made that a composite component will depend on all of its sub necessary components, provided that engineers will not introduce useless necessary sub components into the composite component by mistakes or other reasons, then the functional relation “depAll” could be derived from the physical connection “consists” of the composite component in a straightforward way by removing the spare components in the “consists”.

The logic representation of the example configuration consists of two main parts. One is the constant definitions of components, i.e., names and types of component instances which are denoted in lines 4 to 11. For instance, the constant definition of line 4 states that “sys” is an instance of composite component i.e., the example network system. The second is the relations between these components, which are denoted by the equations in lines 12 to 26. For instance, the equation of line 12 states that the example network system, “sys”, depends on the primary server s1.

Based on the input system configuration shown in FIG. 11, assume that the user select that top event to be analyzed as that the system, “sys”, is down, namely “down(sys)” (corresponding to Step A2 of FIG. 2).

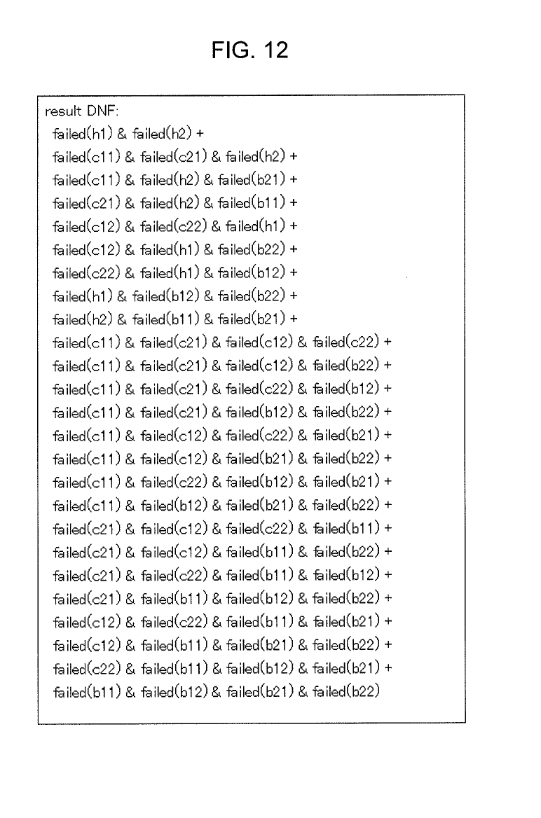

The first decomposition of the top event gets one sub event of “functionless(sys)” by applying the decomposition rule shown in line 13 of FIG. 9, since the instance “sys” is not a primary component, i.e. the example network system does not have any spare (corresponding to Step A3 of FIG. 2). The sub event could be further decomposed by applying the decomposition rule shown in line 9 of FIG. 9, and get a sub event “anyDown(s1)” based on the configuration equations shown in lines 4 and 11 of FIG. 11, i.e. “sys” is a composite hardware component and it depends on the server s1 (corresponding to the repeated execution of Step A3 of FIG. 2). Redo the decomposition step repeatedly and assume that the calculation of MCS is also carried out in a way such as shown in Step B4 of FIG. 4 or Step C4 of FIG. 5, the final MCS of the fault tree with the top event is presented in FIG. 12 (corresponding to Steps B5 and C5 of FIGS. 4 and 5, respectively).

Additionally, while each unit was configured with hardware in the above-described implementation modes and example, it may be configured with a program and a CPU that perform an operation similar to that of each unit.

Above, although the present invention has been particularly described with reference to the preferred implementation modes and the examples, it should be readily apparent to those of ordinary skill in the art that the present invention is not always limited to the above-mentioned embodiment and examples, and changes and modifications in the form and details may be made without departing from the spirit and scope of the invention.

Further, the content of the above-mentioned exemplary embodiments can be expressed as follows.

(Supplementary note 1) A system for static fault tree analysis from system models comprising:

a system configuration input means that inputs system configurations and top events of the systems to be analyzed;

a system model library means that stores a set of system architecture models and component error models; and

a fault tree analysis means that analyzes fault trees of the system from said top events in terms of decomposition rules defined in said component error models:

wherein said system configurations and top events are instances of the system architecture models and the fault events of the component error models stored in said system model library means, respectively;

wherein said system architecture models delimit classification of and definitions of physical and semantic relations between different components; and

wherein said component error models define different fault events of components and their Boolean logic relationships called decomposition rules which cover both functional and sequential dependencies for fault tree analysis.

(Supplementary note 2) The fault tree analysis system according to Supplementary note 1, wherein said system model library means further comprising a MCS calculation means that stores MCS calculation rules for calculating minimal cut sets of the fault trees, removes redundant cut sets of the events based on said MCS calculation rules, and calculates the minimal cut sets.

(Supplementary note 3) A method for static fault tree analysis from system models comprising:

storing, in a system to be analyzed, a set of system architecture models that delimit classification of and definitions of physical and semantic relations between different components, and component error models that define different fault events of components and their Boolean logic relationships called decomposition rules which cover both functional and sequential dependencies for fault tree analysis;

selecting top events of the system to be analyzed; and

analyzing fault trees of the system from said top events in terms of decomposition rules defined in said component error models.

(Supplementary note 4) The fault tree analysis method according to Supplementary note 3 comprising storing MCS calculation rules for calculating minimal cut sets of the fault trees, removing redundant cut sets of the events based on said MCS calculation rules, and calculating the minimal cut sets.

(Supplementary note 5) A program for causing a computer to analyze static fault trees from system models, said program causing the computer to execute:

a process of storing, in a system to be analyzed, a set of system architecture models that delimit classification of and definitions of physical and semantic relations between different components, and component error models that define different fault events of components and their Boolean logic relationships called decomposition rules which cover both functional and sequential dependencies for fault tree analysis; and

a process of analyzing fault trees of the system from the selected top events in terms of decomposition rules defined in said component error models.

(Supplementary note 6) The program according to Supplementary note 5, said program causing the computer to execute a process of removing redundant cut sets of the events based on MCS calculation rules for calculating minimal cut sets of the fault trees, and calculating the minimal cut sets.

This application is based upon and claims the benefit of priority from Japanese patent application No. 2010-117945, filed on May 24, 2010, the disclosure of which is incorporated herein in its entirety by reference.

### INDUSTRIAL APPLICABILITY

The present invention can be used to analyze system reliability with fault trees from system configurations automatically, with the implementation of the aforementioned system model library means defining system architecture models, component error models, and MCS calculation rules, and the aforementioned fault tree analysis (FTA) means for generating fault trees and calculating MCS in terms of the decomposition and reduction rules defined in the aforementioned system model library means, respectively.

### REFERENCE SIGNS LIST

110 system configuration input means

120 system model library means

130 fault tree analysis (FTA) means

121 system architecture model means

122 component error model means

123 MCS calculation means

1. A system for static fault tree analysis from system models comprising:
a system configuration input unit that inputs system configurations and top events of the systems to be analyzed;
a system model library that stores a set of system architecture models and component error models; and
a fault tree analyzer that analyzes fault trees of the system from said top events in terms of decomposition rules defined in said component error models:
wherein said system configurations and top events are instances of the system architecture models and the fault events of the component error models stored in said system model library, respectively;
wherein said system architecture models delimit classification of and definitions of physical and semantic relations between different components; and
wherein said component error models define different fault events of components and their Boolean logic relationships called decomposition rules which cover both functional and sequential dependencies for fault tree analysis.

2. The fault tree analysis system according to claim 1, wherein said system model library further comprising a MCS calculator that stores MCS calculation rules for calculating minimal cut sets of the fault trees, removes redundant cut sets of the events based on said MCS calculation rules, and calculates the minimal cut sets.

3. A method for static fault tree analysis from system models comprising:
storing, in a system to be analyzed, a set of system architecture models that delimit classification of and definitions of physical and semantic relations between different components, and component error models that define different fault events of components and their Boolean logic relationships called decomposition rules which cover both functional and sequential dependencies for fault tree analysis;
selecting top events of the system to be analyzed; and
analyzing fault trees of the system from said top events in terms of decomposition rules defined in said component error models.

4. The fault tree analysis method according to claim 3 comprising storing MCS calculation rules for calculating minimal cut sets of the fault trees, removing redundant cut sets of the events based on said MCS calculation rules, and calculating the minimal cut sets.

5. A non-transitory computer readable storage medium storing a program for causing a computer to analyze static fault trees from system models, said program causing the computer to execute:
a process of storing, in a system to be analyzed, a set of system architecture models that delimit classification of and definitions of physical and semantic relations between different components, and component error models that define different fault events of components and their Boolean logic relationships called decomposition rules which cover both functional and sequential dependencies for fault tree analysis; and
a process of analyzing fault trees of the system from the selected top events in terms of decomposition rules defined in said component error models.

6. The non-transitory computer readable storage medium storing a program according to claim 5, said program causing the computer to execute a process of removing redundant cut sets of the events based on MCS calculation rules for calculating minimal cut sets of the fault trees, and calculating the minimal cut sets.
